(19) United States
(12) Patent Application Publication
(10) Pub. No.: US 2004/0059586 A1
(43) Pub. Date: Mar. 25, 2004

(54) System and method for updating real estate web sites

(76) Inventors: Andrew B. Brimberry, Fort Worth, TX (US); Greggory H. Reisig, Dallas, TX (US); Timothy L. Farmer, Arlington, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/255,164

(22) Filed: Sep. 25, 2002

(51) Int. Cl. G06F 17/60

(52) U.S. Cl. 705/1

(57) ABSTRACT

A system and method for updating real estate web sites includes a user interface, such as a web based user interface, for allowing authorized personnel of a developer to specify relevant information about a property, such as location, price range, floor plans, contact information, directions, and/or the like, for display in predefined areas of web pages on the web site. The information is stored in one or more databases. Predefined web pages are populated with the information.

### TECHNICAL FIELD OF THE INVENTION

The present invention relates to a system and method for updating real estate web sites.

### BACKGROUND AND SUMMARY OF THE INVENTION

Individuals, such as sales and/or marketing people who are involved with marketing real estate developments, particularly residential real estate developments, typically do not have the requisite knowledge to update the web sites related to the development. Furthermore, for security reasons, access to web sites files are typically limited. Generally, only a small number of people responsible for its operation have access to such files. Consequently, marketing and others within a developer's organization that want to make changes to information on a web site must ask the manager of the web site to make changes to it.

The invention has an general objective allowing changes to information on web sites for real estate developments to be made by those who do not have access to a production instance of the web site files, or who know nothing about programming for web sites. A real estate development's web site can thus be easily kept current. Furthermore, a web site for a new development could, if desired, also be set up quickly. The invention may be used to particular advantage by a builder or developer who has many subdivisions or developments, or can be made available as a service for use by many different developers or builders.

In its preferred embodiment, the invention contemplates web pages for a real estate development web site that have predefined areas containing editable information about the real estate development. The information is stored in a database that is accessed by a web server dynamically generating the web sites actual web pages. A user, such as a marketing or sales person, may edit this information, preferably through an interactive web page. These editable areas may include, for example, information on location, price ranges, floor plans, contact information, directions, phone number, school district information, price range, special offers, information on the metropolitan area, address information, directions and other such information. Information may be selected from another source, such as a database containing floor plans for a unit (e.g. a single family home). Thus, for example, in the case of a residential subdivision, a floor plan may be selected from a list of stock house designs approved for building in the subdivision by the developer. Or, it can be a floor plan of an existing house that may be featured.

Other features of the preferred embodiment of the invention are disclosed below in connection with an example of a system for updating a real estate development web site and an example of a web site for a single family housing subdivision. The invention is not, however, limited to its preferred embodiment or to the specific examples given.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an exemplary web page for a real estate development;

FIG. 2 is an example of a layout of a page for a real estate development web site;

FIGS. 3a-3f are exemplary screen displays of a software tool for updating a real estate development web site; and

FIG. 4 is an exemplary screen display of a map for a real estate development selecting a real estate development's web site for viewing.

### DETAILED DESCRIPTION OF THE DRAWINGS

As used in the following description, a web site is collection of related web pages or documents that are linked together in some fashion and made available over a network from one or more services. The pages are viewable in a browser or other application capable of rendering the page according to coding contained in the pages. A web page or document may contain, in addition to text and graphics, animations and videos. A real estate development refers to a single family or multi-family housing development, a housing subdivision, an apartment building, a commercial office park or building, or similar development.

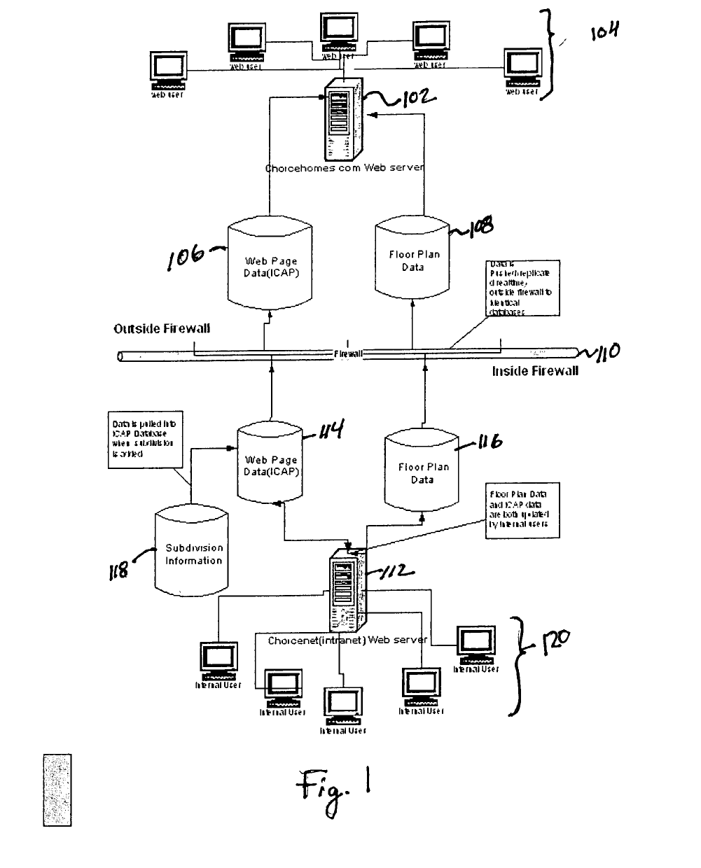

Referring to FIG. 1, production web server 102 makes available a public real estate development web site on the Internet or other public network. Multiple, distributed web servers can be used in place of single web server if desired. Web site user computers 104 are representative of computers and other communication devices capable of accessing the web server. The web server dynamically creates or generates HTML or similarly encoded pages for viewing in web browsers running on computers 104. The web pages are generated using, for example CGI, Active Sever Page (ASP), Cold Fusion, or other types of scripts stored in web page database 106. The scripts pull text, graphics, video, applets or other information that may be stored in the database 106 or another database, such as a floor plan database 108. As discussed below, at least portions of this information is specified or provided by users of a web site information editing system and process, who do not otherwise have access to the web site programming.

Because web server 102 and databases 106 and 108 are connected to a public network, it is preferred to have a secure web server and databases acting in effect as a backup and for running software that permits maintaining and updating the web site. Behind firewall 110 are a secure web server 112, a secure web page database 114 and a secure floor plan database 116. The firewall is representative only of a mechanism for securing web server 112, web page database 114 and secure floor plan database 116 against unauthorized access. Production databases 106 and 108 are synchronized to secure databases 114 and 116 whenever there is an update to the secure databases or on some sort of schedule. The secure web server is available certain users 120, who are labeled “internal” users to differentiate them from public web site users. However, the internal users need not be located at the same location or on a single private network. Rather, virtual private networks (VPNs) or other types of mechanisms could be used to provide secure connections to the secure web server 112.

Web server 112 runs software for enabling authorized users to update data or information used in dynamically created web pages for the real estate development web site. This information or data is development-specific, meaning that it is inserted into generic web page formats when web pages are generated on the public web site for the real estate development. The software will be referred to as web site data editing software. Although only one instance of the software is contemplated in the given example, the web page data editing software may exist in multiple instances. The software executes on a computing platform and is preferably implemented as a web-based application using scripts (e.g. CGI, Active Server Page, Java, Cold Fusion) that are interpreted in real time. However, it can be implemented using client-server software. In its preferred embodiment, internal users access use of this software through a web browser or similar rendering application preferably access this software, with the software generating web pages with which the internal users interact to update web pages. These web pages will be referred to herein as edit pages. The information or data is stored in web page database 114.

Certain of the development-specific information may be pulled from other databases. In the given example, information on subdivisions, maintained by a builder or developer for other purposes, is stored in subdivision database 118. It is either copied into web page data 114 or is associated or linked with it. When the web page data stored in database 114 is replicated to production database 106, this information is copied to the production database.

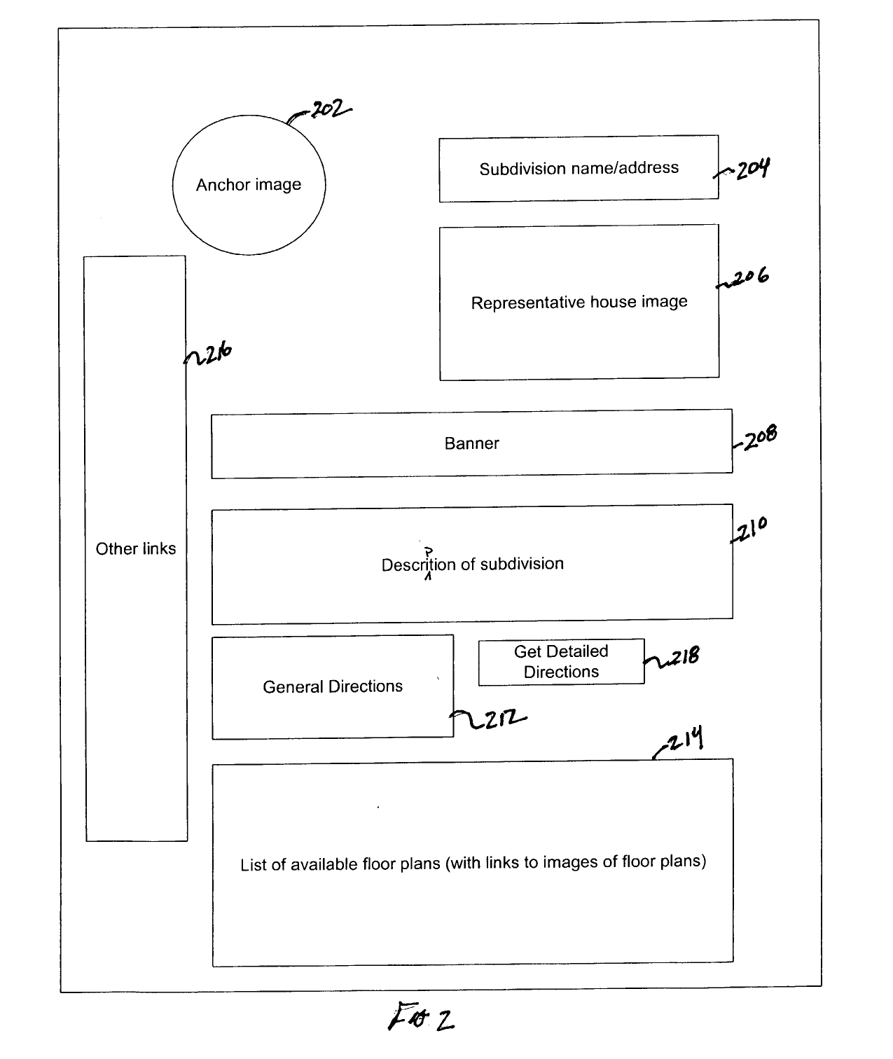

FIG. 2 is an example of a generic layout or template for a home page for a real estate development, in this case for a residential subdivision of a builder that will be populated with development-specific data supplied or selected by a user. The layout includes as editable elements an anchor image 202, the name and address or location of the subdivision 204, an image of a representative residence and accompanying description 206, an advertising banner 208, a description of the subdivision 210 to provide more detailed information on the development, general directions to the development 212, and, since the given example is a residential subdivision, a listing of floor plans 214 available in the division with links to images of the floor plans. General directions may include a link to a map or a mapping service that displays the location of the development on a road map. Other editable information may include contact information, phone numbers, school district information, and price ranges. For other types of developments, floor plans of representative units or of actual spaces could be provided. The page may also include additional graphics, backgrounds, and links 216 that are part of the template and not editable. Backgrounds, graphics and other features that could otherwise be found on such a web page have not been shown.

Each real estate development (e.g. subdivision) has at least one page such as the one shown in FIG. 2 containing specific information about the real estate development. This development-specific information is selected or provided by a person with privileges to do so, such as such as a manager, marketing specialist, or other employee of a developer or builder. In order to maintain a consistent look and feel between pages on the web site, or between web sites for different developments of a developer or builder, other graphics, fonts, colors, links, are generally not editable by the user. These are only editable by the web site programmer. However, the positions of some of these elements, or a choice to include certain of the elements, could be given to the user. Additionally, text fonts, colors and other visual characteristics will typically also be defined and not editable in order to maintain a consistent appearance. Additional elements could be defined for the page or on additional pages.

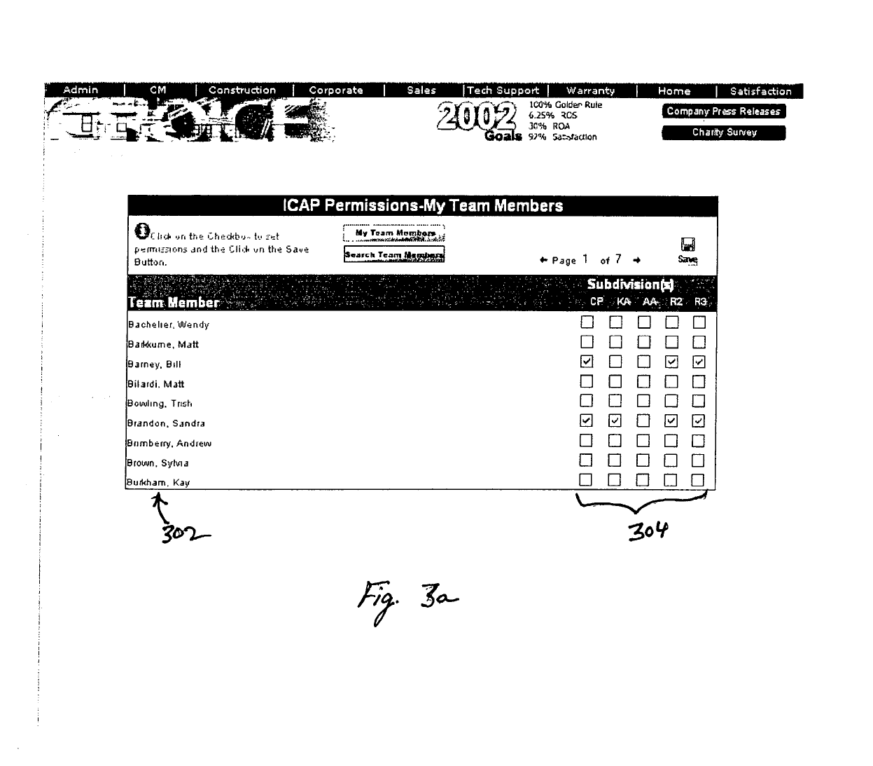

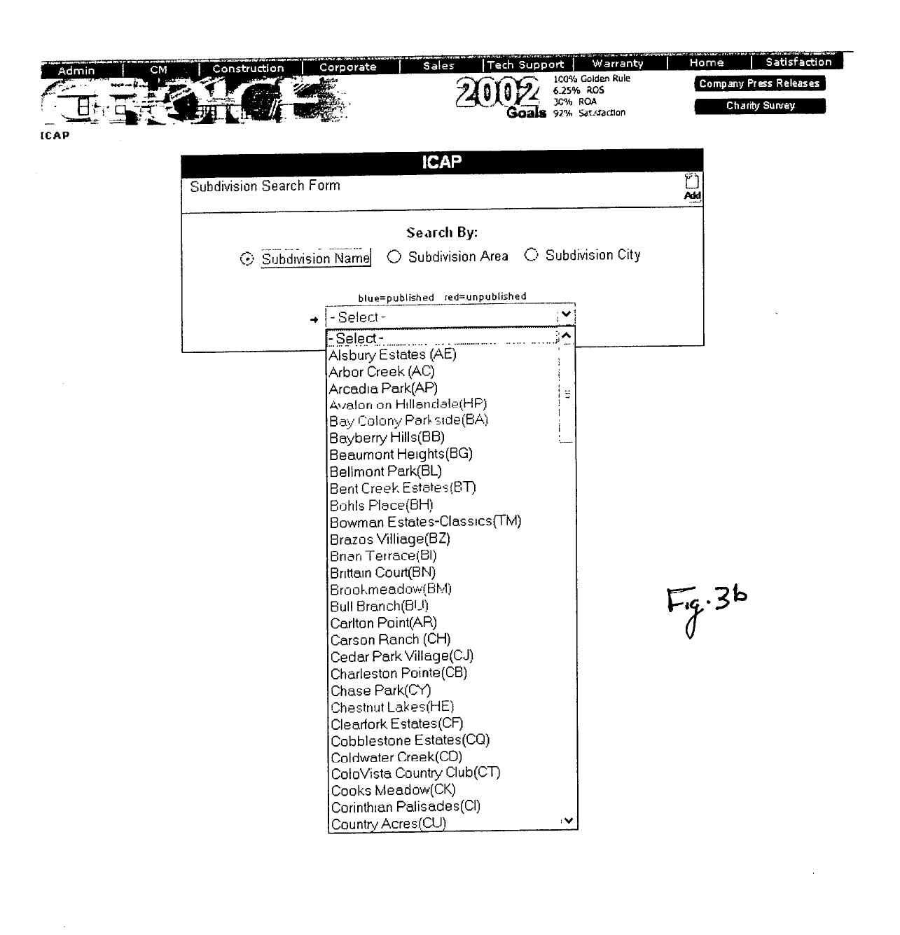

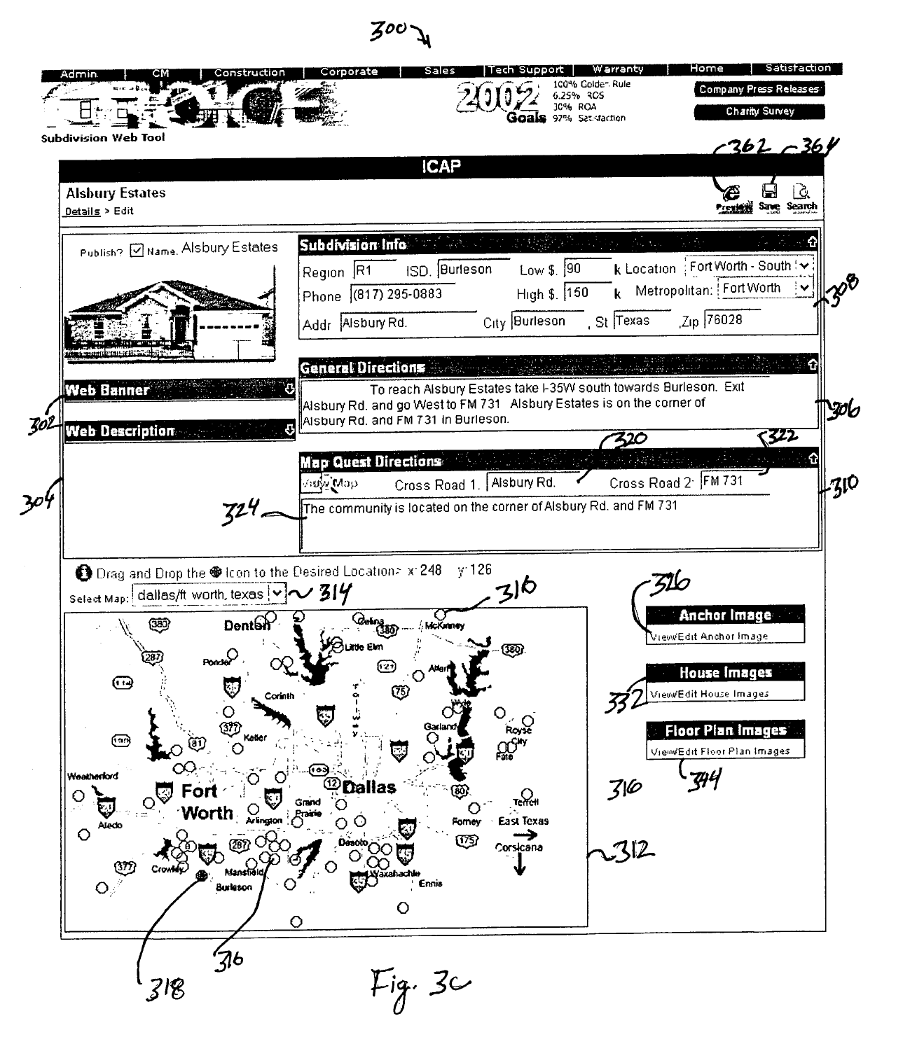

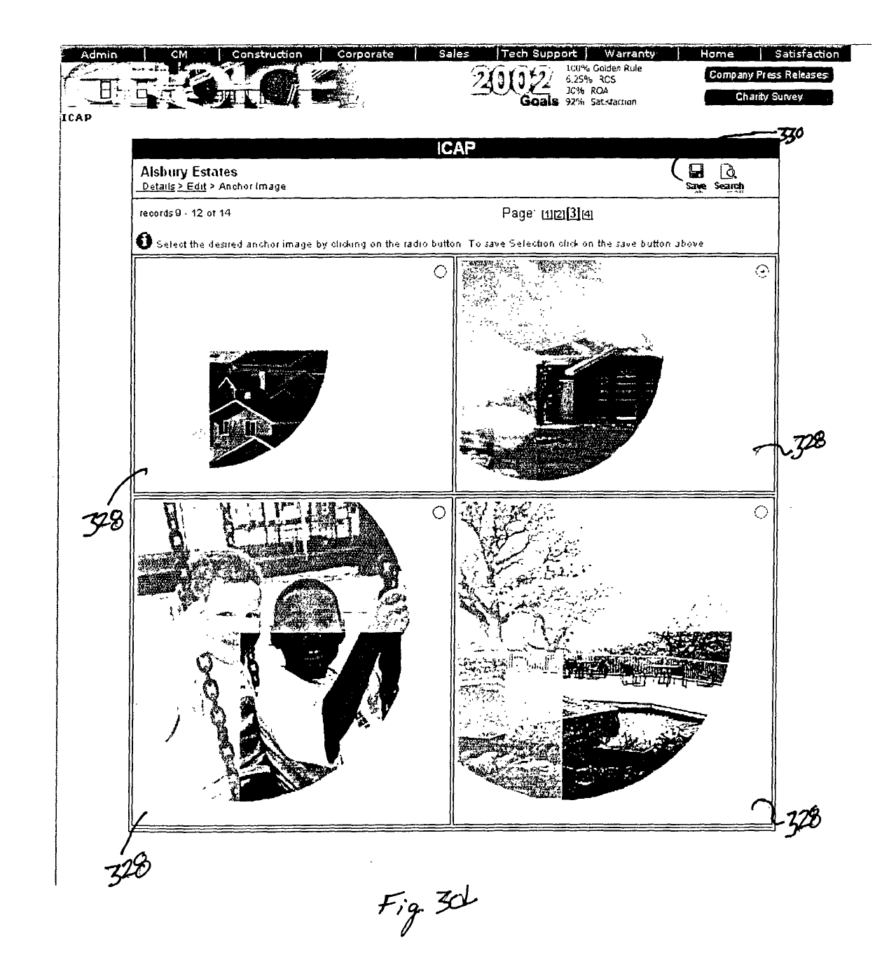

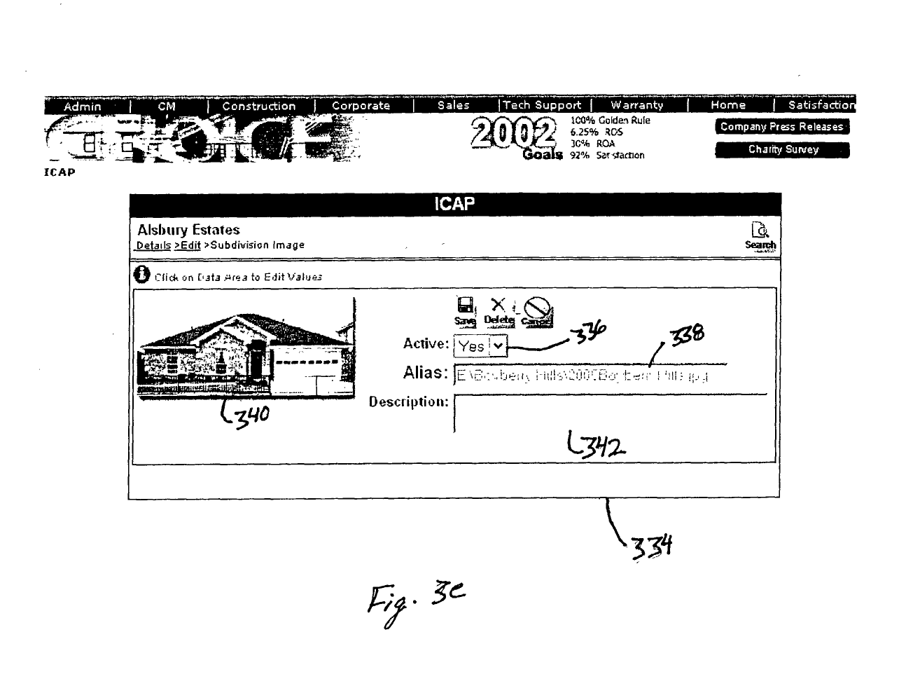

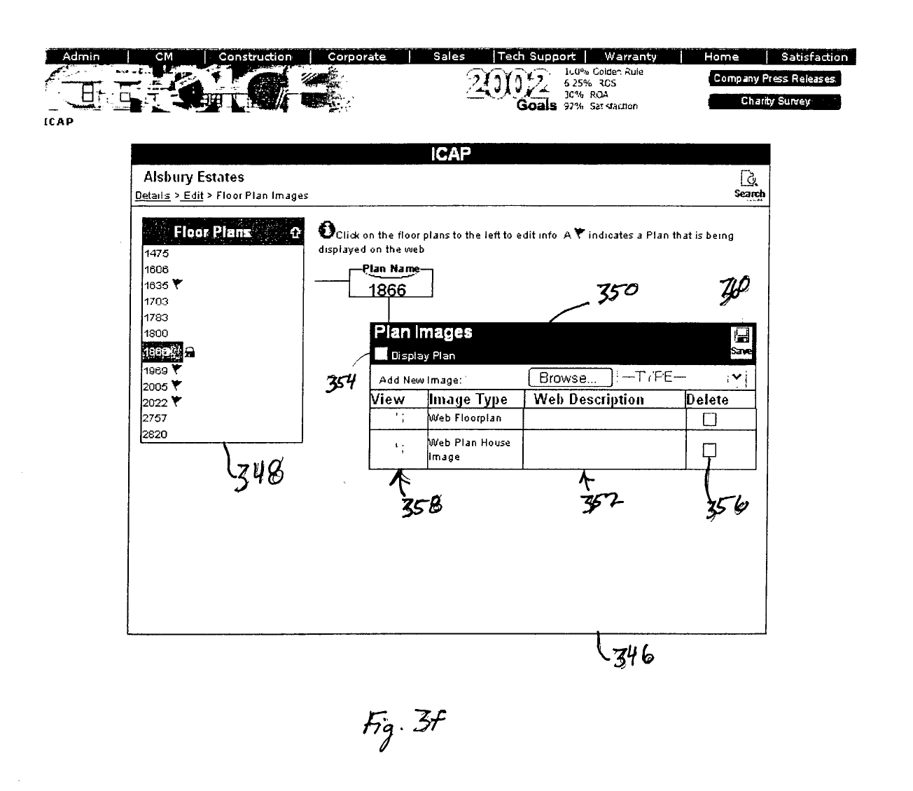

FIGS. 3a-3f illustrate user interfaces pages for the web site data editing software for real estate developments. The particular example given is for a builder or developer with multiple residential subdivisions. The web site data editing software is particularly useful for web sites for such real estate developments and has particular advantage in this application, especially if the developer has subdivisions located in multiple metropolitan areas.

FIG. 3a illustrates a web page for an administrator or manager to assign users 302 to real estate developments 304 (in this example, residential subdivisions). In this example, users may be added to one or more teams. When a user is assigned to a development for which the team is responsible, the user is assigned permissions to specify, view, add, edit and delete privileges. The dialog box for setting the permission is not shown, but it may include whether the user has read only privileges, editing privileges (which could be field limited), and/or deletion privileges. For example, certain critical information about the real estate development may only be editable by a manager, while other marketing relating information may be edited by other team members.

As shown in FIG. 3b, when a user enters the system, the user chooses a subdivision for editing from a menu. A property may be located through a search by property name, property area, and/or property city. Upon performing a search, a list of properties may be displayed. Different color codes or other visual indicators may be used to differentiate between properties that have already been published on the web site and properties that have not been published on the web site. New subdivisions can be added by selecting an “add” button.

The user is then presented with a main edit screen. FIG. 3c is an example of such a main edit screen. Main edit screen 300 has a corresponding layout to the web page. Each editable element in the web page preferably has a separate box or window. Each window has a title bar labeled with the element's name or purpose and a button (labeled with an arrow icon) for collapsing or expanding the window to see its contents. When first displayed, each window is populated with stored information, if any, from one or more databases storing the data. In the example of FIG. 1, this data is stored in web page database 114, subdivision information 118 and floor plan data 116. For purposes of illustration, the windows in main edit screen 300 correspond to the editable elements of the exemplary web page of FIG. 2. Referring briefly also to FIG. 2, web banner window 302 corresponds to web banner element 208. Web description 304 corresponds to description 210. General directions 306 corresponds to general directions 212 in FIG. 1. These are freely editable text fields.

Subdivision information in window 308 is field limited. This information may be stored, for example, stored in subdivision information database 118 of FIG. 1. It includes fields specifying a region for the subdivision, its school district, high and low prices for homes in the subdivision, a contact number, the metropolitan area of the subdivision and its address. This information used not only for subdivision-specific web pages—for example, to populate subdivision name/address element 204—but also in web pages that are used by a web user to navigate to or select a particular subdivision. For example, a developer may have many subdivisions all over the country and in several metropolitan areas within a state. Once reaching, for example, a home page for the developer, a web user would navigate to the web site for the particular subdivision by specifying a state, for example, then a metropolitan area, and then a particular subdivision.

Window 312 displays a map of the subdivision's metropolitan area. The metropolitan area is selected from drop down window 314. Each dot 316 represents the location of a particular subdivision. A special icon 318 represents the subdivision be located. It can be dragged to any location within the map and saved. Once saved, a dot will appear at that location each time the map is displayed other than in the edit mode for the particular subdivision. This mapping tool is especially advantageous for stylized maps that may not be to scale or otherwise have information for associating coordinates on the map to geographic coordinates. It is also advantageous in situations where it is not necessary or desirable to locate the position of a development according to precise coordinates.

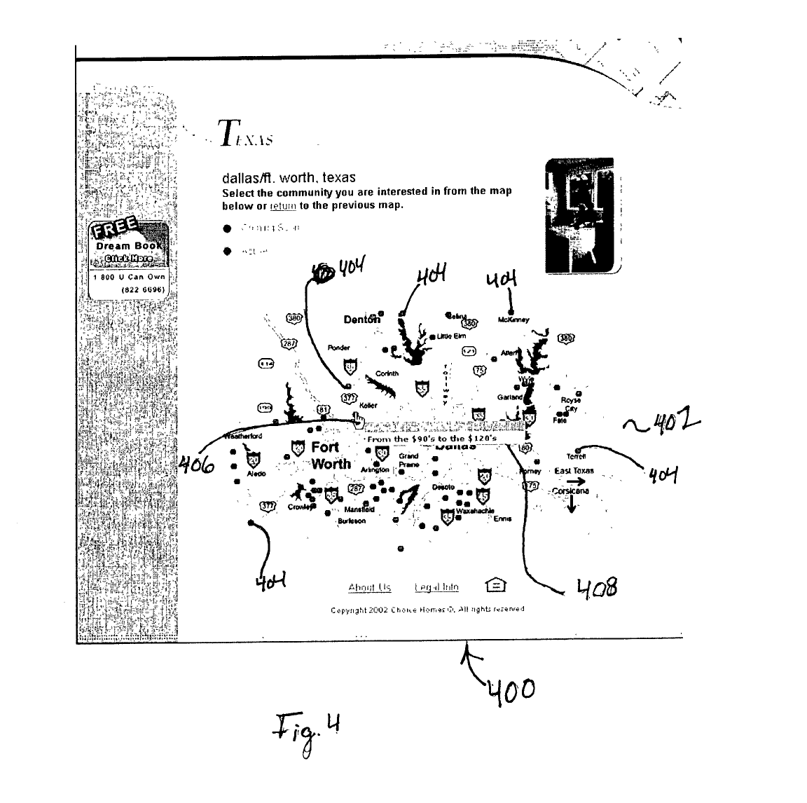

Referring briefly to FIG. 4, one use of a metropolitan area map is in navigation to, or selection of, a particular real estate development web site. FIG. 4 is an example of such use. Within web page 400, metropolitan area map has displayed on it a plurality of dots 404, each corresponding to an actual or proposed real estate development (residential subdivisions in this example). Hovering cursor 406 over a dot causes a bubble or dialog window 408 to be displayed with information about the development. In this example, this information includes the name of the subdivision and price ranges of homes in the subdivision. However, it could include additional information. Each dot also contains a link to the development's home page. Clicking on the dot loads the home page of the real estate development.

Referring back to FIG. 3c, illustrated is an interface of a tool for generating directions to real estate development from a starting point specified by web site user. The tool is useful for developments, such as subdivisions, located on roads that are too new to be shown on maps generated or used by third party services offering mapping and directions. Directions window 310 permits additional directions to be added at the end of directions generated by a mapping or direction services such as Map Quest® or Mapblast®. Nearest crossroad information is supplied in fields 320 and 322, and directions from those crossroads to the development are entered in field 324. When a web site viewer selects button 218 (see FIG. 2), a script is executed that supplies the mapping service with the cross-roads as a destination and the additional text as directions from the cross-roads. The web site user enters the starting address or intersection. A request for directions from the web site user's starting address to the cross-roads is sent to the mapping service. The service then generates and returns specific, detailed directions to the crossroads specified. The returned directions are appended with the directions from the crossroads to the development and displayed.

Selecting button 326 takes the user to the web page shown in FIG. 3d, which displays a plurality of images 328 from which the user may select for anchor image 202 (FIG. 2). Multiple pages of anchor images may be available. The user selects save button 330 to save the selected choice. Selecting button 332 in screen 300 of FIG. 3c takes the user to a web page such as the one in FIG. 3e displaying representative house selection window 334. The window includes a field 336 for specifying whether or not the element is active, meaning whether or not it is to be displayed on the web site page, a field 338 for specifying the path to an image of the representative house, and a text field 342 for entering a brief description of the house that will be displayed under the image on the web site page. The specified image 340 is also displayed in the window.

Selecting button 344 in the main edit screen 300 (FIG. 3c) takes the user to a floor plan edit page 346 such as the one shown in FIG. 3f. The floor plan edit page enables selection of plans to be listed in, for example, element 214 of FIG. 2 of the representative web page. The page includes a list of floor plans in window 348. This list is generated from floor plan database 116. Plans that are selected for display in the web page are indicated by an icon, such as a flag. To edit a floor plan, the floor plan is selected using window 350. Images for the floor plan and a house with the floor plan are specified by paths or links to the images. Brief descriptions of the images can be added in fields 352 for display on the web site page. The images will not be displayed unless the “Display Plan” box 354 is checked. Images can also be deleted by checking boxes 356 or viewed by clicking icons 358. Selecting “Save” button 360 saves the edits. Each floor plan may include one or more of the following piece of information: square footage, number of bedrooms, number of bathrooms, number of garages, number of levels, and/or the like. This information, stored in floor plan database 116, will be displayed on the web page in the list of displayed floor plans. A web site user may view a floor plan by selecting a hyperlink on the web page.

Referring back to FIG. 3c, selecting preview button 362 permits the user to preview the actual web site page based on the information that has been saved. Selecting “Save” button 364 saves the information as edited to the web page database.

The web site information editing software for real estate developments described above may also be provided to multiple real estate developers as, for example, an application service and/or in conjunction with web site hosting and/or development.

While the invention has been particularly shown and described by the foregoing detailed description, it will be understood by those skilled in the art that various other changes in form and detail may be made without departing from the spirit and scope of the invention.

What is claimed is:

1. A method for updating a real estate web site, comprising:
providing a graphical user interface for editing real estate information to be displayed in predefined elements of a web page of a web site for a real estate development;
storing said real estate information in a database; and
generating the web page with said real estate information in the predefined elements.

2. The method of claim 1, wherein the web page comprises a list of available floor plans.

3. The method of claim 1, wherein the predefined elements include a description of the development.

4. The method of claim 1, wherein the predefined elements include a representative image of the development.

5. The method of claim 1, wherein the graphical user interface is a web interface with one or more text entry windows corresponding to one or more of the predefined elements of the web page.

6. The method of claim 1, wherein the graphical user interface includes one or more windows containing information for selection for display in one or more of the predefined elements of the web page.

7. The method of claim 1, wherein the web site includes a map displaying an icon identifying a geographic location of the real estate development, and includes a link to the web page for the real estate development; wherein the graphical user interface includes a interactive display of the map for specifying with respect to the map the position of the icon identifying the real estate development's geographic location.

8. Computer readable media for storing instructions that, when performed by a computer, cause execution of a method for updating a real estate web site, comprising:
providing a graphical user interface for editing real estate information to be displayed in predefined elements of a web page of a web site for a real estate development;
storing said real estate information in a database; and
generating the web page with said real estate information in the predefined elements.

9. The computer readable media of claim 8, wherein the web page comprises a list of available floor plans.

10. The computer readable media of claim 8, wherein the predefined elements include a description of the development.

11. The computer readable media of claim 8, wherein the predefined elements include a representative image of the development.

12. The computer readable media of claim 8, wherein the graphical user interface is a web interface with one or more text entry windows corresponding to one or more of the predefined elements of the web page.

13. The computer readable media of claim 8, wherein the graphical user interface includes one or more windows containing information for selection for display in one or more of the predefined elements of the web page.

14. The computer readable media of claim 8, wherein the web site includes a map displaying an icon identifying a geographic location of the real estate development, and includes a link to the web page for the real estate development; wherein the graphical user interface includes a interactive display of the map for specifying with respect to the map the position of the icon identifying the real estate development's geographic location.
